(19) United States
(12) Patent Application Publication
(10) Pub. No.: US 2024/0217068 A1
(43) Pub. Date: Jul. 4, 2024

(54) Multi-specification pliers with an easily replaceable clamping head

(71) Applicant: YUYAO CITY SANJIAN TOOL CO., LTD, Yuyao City (CN)

(72) Inventor: Jianjun HAN, Yuyao (CN)

(21) Appl. No.: 18/149,039

(22) Filed: Dec. 30, 2022

(51) Int. Cl. B25B 7/04; B25B 7/06

(52) U.S. Cl. CPC B25B 7/04; B25B 7/06; B25B 7/22

(57) ABSTRACT

A multi-specification pliers with an easily replaceable clamping head includes a handle and a detachable clamping head connected to the handle; the handle comprises a handle insert arranged at the front end; a limit counter bore is processed on the handle insert, with the first bevel on the one side and the second bevel on the other side of the limit counter bore; the clamping head includes the third bevel arranged at the rear end; a limiting boss is processed on the clamping head side; the first bevel is matched to the third one; and the limit counter bore is matched to the limiting boss. The clamping head and handle can be connected quickly and stably for realizing multiple use of the handle, saving materials and costs, and solving the problem of the existing circlip pliers with a replaceable clamping head for not compatible with large-torque pliers.

### FIELD OF THE INVENTION

The present invention relates to the technical field of hand tool, more specifically to a multi-specification pliers with an easily replaceable clamping head.

### BACKGROUND ART

At present, most of the multifunctional circlip pliers with replaceable clamping head available for sale on the market adopt external torsion springs, and superimposed limit structure by double coaxial and four fasteners. Multiple clamping heads can be disassembled and connected to the handle relying on this structure so as to achieve multiple use. However, such multifunctional circlip pliers with replaceable clamping head still presents the following shortcomings in practical applications:
(1) When replacing the clamping head of different specifications, remove the fasteners with a tool first or press hardly on both sides of the center shaft of the clamping head. Toggle the lock pin to make it rotate for 90° to the vertical direction and then remove the clamping head. After that, lock the fasteners or toggle the lock pin to make it rotate for 90°, and then lock the clamping head to complete the replacement. The replacement is quite complicated, especially under special working conditions (For example, when working at high altitude, one hand sometimes needs to maintain body balance, and when working in dark environment, one hand needs to hold lighting equipment).
(2) If the replaced clamping head accidentally hits the tail during operation, it is easy to make the clamping head turn away from the positioning guide pillar of the handle and result in function failure. The operator shall re-load the clamping head to the positioning guide pillar of the handle before continue to use.
(3) This form is limited to the structure of circlip pliers, but not applicable to pliers of other functions.
(4) This structure is poor in structure rigidity and torque.

Therefore, it is necessary to invent a kind of multifunctional pliers with replaceable clamping head which is easy to replace the clamping head and not prone to causing functional failure.

### INVENTION CONTENTS

In order to solve the above problems, a multi-specification pliers with an easily replaceable clamping head is proposed in this invention.

Technical proposal of the invention: a multi-specification pliers with an easily replaceable clamping head; it consists of a handle and a detachable clamping head connected to the said handle; the said handle comprises a handle insert arranged at the front end; a limit counter bore is processed on the said handle insert, with the first bevel on the one side and the second bevel on the other side of the said limit counter bore; the said clamping head includes the third bevel arranged at the rear end; a limiting boss is processed on the said clamping head side; the said first bevel is matched to the third one; and the said limit counter bore is matched to the said limiting boss.

Further more, the said front end of the handle is provided with a positioning hole, and the said positioning hole is matched to the said limiting counter bore; a fastener is available between the said location hole and the said limit counter bore; the said handle is connected by the said handle insert with fasteners.

Further more, the said handle is connected to the handle insert by welding.

Further more, the said handle includes an upper handle and a lower handle; the said upper handle and the lower handle are flexibly connected by two handle fasteners.

Further more, the said handle insert consists of the upper handle insert and the lower handle insert; an arc is processed on the side of the said upper handle insert and a semi-arc is processed on the front side of the said lower handle; the said arc is matched to the said semi-arc for limiting the start/end position of the opening and closing of the upper handle and the lower handle.

Further more, the said clamping head is provided with a separate torsion spring.

Further more, the said clamping head consists of a scissors, an oblique-mouth component, a sharp-mouth component, a wire-cutter and a wire stripping pliers.

The multi-specification pliers with an easily replaceable clamping head claimed in the present invention is characterized by simple structure, strong rigidity, high torsion and ease-to-use. The clamping head can be quickly inserted into the handle, and fit to the third bevel properly via the first bevel of the handle insert; through double limiting of fitting the limit boss to the limit counter bore, the clamping head and handle can be connected quickly and stably for realizing multiple use of the handle, saving materials and costs, and solving the problem of the existing circlip pliers with a replaceable clamping head for not compatible with large-torque pliers due to the complex clamping head replacing steps, poor structure rigidity, small torque and narrow application scope.

### DESCRIPTION OF THE DRAWINGS

FIG. 1 Structural diagram of the invention;

FIG. 2 Structural explosion diagram of the invention;

FIG. 3 Partial structure cross-sectional view of the upper handle insert and the lower handle matching limit;

FIG. 4 Structural diagram of the sharp-mouth component;

FIG. 5 Structural diagram of the scissors;

FIG. 6 Structural diagram of the oblique-mouth component;

FIG. 7 Structural diagram of the wire-cutter;

FIG. 8 Structural diagram of the wire stripping pliers;

In the figure, handle—1, clamping head—2; handle insert —1.1, limit counter bore—1.2, first bevel—1.3,
second bevel—1.4, positioning hole—1.5, fastener —1.6, upper handle —1.7, lower handle—1.8,
Handle fastener—1.9, semi-arc—1.10; third bevel—2.1, limit boss—2.2, independent torsion spring—2.3, scissors—2.4, oblique—mouth component—2.5, sharp-mouth component—2.6, wire-cutter—2.7, wire stripping pliers—2.8; upper handle insert—1.1.1, lower handle insert—1.1.2, arc—1.1.3.

### MODE OF CARRYING OUT THE INVENTION

The multi-specification pliers with an easily replaceable clamping head in the present invention is introduced in detail combining with the attached figures.

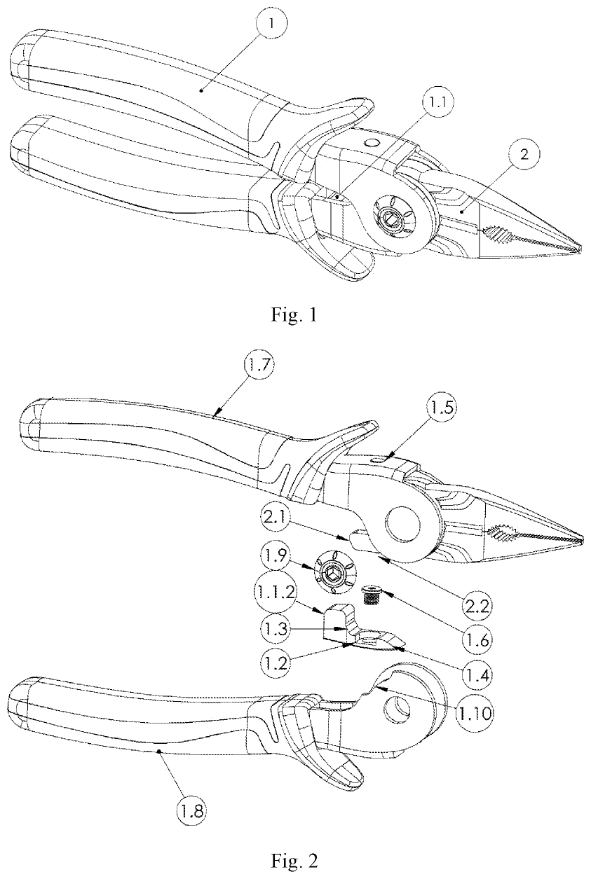

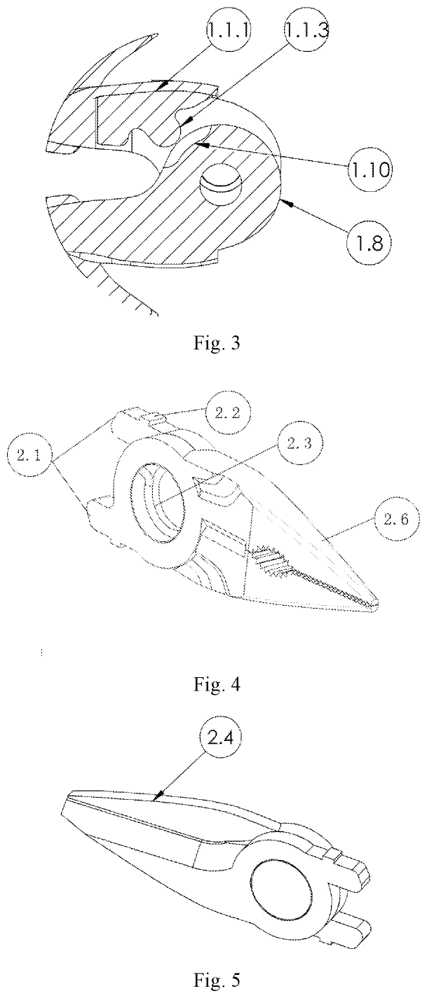

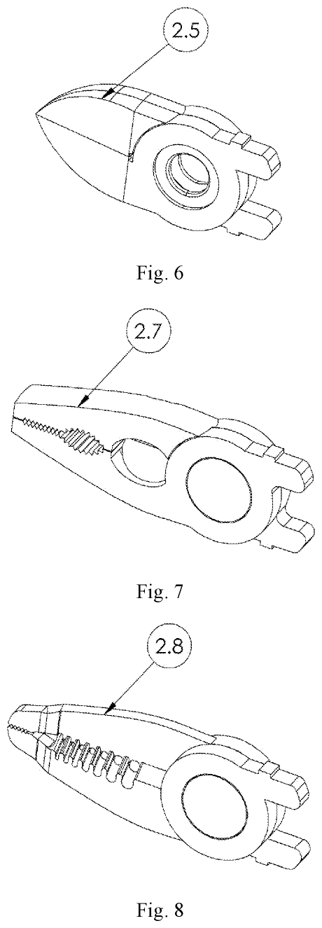

As shown in FIG. 1, FIG. 2, FIG. 3, FIG. 4, FIG. 5, FIG. 6, FIG. 7 and FIG. 8, the multi-specification pliers with an easily replaceable clamping head consists of a handle 1 and a detachable clamping head 2 connected to the handle; the handle 1 comprises a handle insert 1.1 arranged at the front end; a limit counter bore 1.2 is processed on the handle insert 1.1, with the first bevel 1.3 on the one side and the second bevel 1.4 on the other side of the limit counter bore 1.2; the clamping head 2 includes the third bevel 2.1 arranged at the rear end; a limiting boss 2.2 is processed on the clamping head side 2; the first bevel 1.3 is matched to the third one 2.1; and the limit counter bore 1.2 is matched to the limiting boss 2.2; a location hole 1.5 is processed at the handle 1; the location hole 1.5 is matched to the limit counter bore 1.2; a fastener 1.6 is available between the location hole 1.5 and the limit counter bore 1.2; the handle 1 is connected to the handle insert 1.1 by fastener 1.6. The handle 1 is connected to the said handle insert 1.1 by welding. The handle 1 consists of the upper handle 1.7 and the lower handle 1.8; the said upper handle 1.7 and the lower handle 1.8 are flexibly connected by two handle fasteners 1.9. The handle insert 1.1 consists of the upper handle insert 1.1.1 and the lower handle insert 1.1.2; an arc 1.1.3 is processed on the side of the upper handle insert 1.1.1 and a semi-arc 1.10 is processed on the front side of the lower handle 1.8; the clamping head 2 is provided with an independent torsion spring 2.3;

The clamping head 2 consists of a scissors 2.4, an oblique-mouth component 2.5, a sharp-mouth component 2.6, a wire-cutter 2.7 and a wire stripping pliers 2.8.

In actual operation, the user only needs to take the required clamping head 2 and insert the front end of the handle 1 to complete clamping head installation; during the insertion, the second bevel 1.4 plays a guiding role, enabling the clamping head 2 to be inserted more quickly. The first bevel 1.3 fits the third bevel 2.1 properly in the handle insert 1.1. Through double limiting of fitting the limit boss 2.2 to the limit counter bore 1.2, the clamping head 2 and handle 1 can be connected quickly and stably.

The specifications described above are merely preferred embodiment of the present invention, but not imposing any limitation to the invention. Although the present invention has been disclosed as above in preferred embodiment, it is not intended to define the present invention. Any technical person familiar with the profession can utilize the technical contents revealed above to make some modifications or changes as equivalent embodiment within the scope of the technical proposal of the invention. However, any simple modifications, equivalent changes or changes made to the above embodiment according to the technical essence of the invention within the scope of the technical proposal of the invention are still classified into the scope of the technical proposal of the invention.

What is claimed is:

1. A multi-specification pliers with an easily replaceable clamping head, which is characterized as follows: It consists of a handle (1) and a detachable clamping head (2) connected to the handle (1); the said handle (1) comprises a handle insert (1.1) arranged at the front end; a limit counter bore (1.2) is processed on the said handle insert (1.1), with the first bevel (1.3) on the one side and the second bevel (1.4) on the other side of the said limit counter bore (1.2); the said clamping head (2) includes the third bevel (2.1) arranged at the rear end; a limiting boss (2.2) is processed on the said clamping head (2) side; the said first bevel (1.3) is matched to the third one (2.1); and the said limit counter bore (1.2) is matched to the said limiting boss (2.2).

2. A multi-specification pliers with an easily replaceable clamping head as described in claim 1, which is characterized as follows: A location hole (1.5) is processed at the said handle (1); the said location hole (1.5) is matched to the said limit counter bore (1.2); a fastener (1.6) is available between the said location hole (1.5) and the said limit counter bore (1.2); the said handle (1) is connected to the said handle insert (1.1) by the said fastener (1.6).

3. A multi-specification pliers with an easily replaceable clamping head as described in claim 2, which is characterized as follows: the said handle (1) is connected to the said handle insert (1.1) by welding.

4. A multi-specification pliers with an easily replaceable clamping head as described in claim 3, which is characterized as follows: the said handle (1) consists of the upper handle (1.7) and the lower handle (1.8); the said upper handle (1.7) and the lower handle (1.8) are flexibly connected by two handle fasteners (1.9).

5. A multi-specification pliers with an easily replaceable clamping head as described in claim 4, which is characterized as follows: The said handle insert (1.1) consists of the upper handle insert (1.1.1) and the lower handle insert (1.1.2); an arc (1.1.3) is processed on the side of the said upper handle insert (1.1.1) and a semi-arc (1.10) is processed on the front side of the said lower handle (1.8); the said arc (1.1.3) is matched to the said semi-arc (1.10) for limiting the start/end position of the opening and closing of the upper handle (1.7) and the lower handle (1.8).

6. A multi-specification pliers with an easily replaceable clamping head as described in claim 1, which is characterized as follows: The said clamping head (2) is provided with an independent torsion spring (2.3).

7. A multi-specification pliers with an easily replaceable clamping head as described in claim 6, which is characterized as follows: The said clamping head (2) consists of a scissors (2.4), an oblique-mouth component (2.5), a sharp-mouth component (2.6), a wire-cutter (2.7) and a wire stripping pliers (2.8).
